(19) United States
(12) Patent Application Publication
(10) Pub. No.: US 2024/0078716 A1
(43) Pub. Date: Mar. 7, 2024

(54) INTELLIGENT GENERATION OF THUMBNAIL IMAGES FOR MESSAGING APPLICATIONS

(71) Applicant: Citrix Systems, Inc., Fort Lauderdale, FL (US)

(72) Inventors: Tianyu XIAO, Nanjing (CN); Peng YAO, Nanjing (CN)

(21) Appl. No.: 17/933,201

(22) Filed: Sep. 19, 2022

Related U.S. Application Data
(63) Continuation of application No. PCT/CN2022/116746, filed on Sep. 2, 2022.

(51) Int. Cl. G06T 11/00; G06F 40/20; G06V 10/24; G06V 20/70; G06V 30/10; H04L 51/10

(52) U.S. Cl. CPC G06T 11/00; G06F 40/20; G06V 10/245; G06V 20/70; G06V 30/10; H04L 51/10

(57) ABSTRACT

In one aspect, an example methodology implementing the disclosed techniques can include, by a computing device, determining a topic of an electronic messaging session and determining whether a message including an image is being sent within the messaging session. The method can also include, responsive to a determination of a sending of a message including an image within the messaging session, by the computing device, determining contents of the image associated with the topic of the messaging session, generating a thumbnail image to include the contents of the image associated with the topic of the messaging session, and sending the generated thumbnail image with the message to another computing device. The another computing device can be a client associated with a recipient of the message.

### CROSS REFERENCE TO RELATED APPLICATIONS

This application is a continuation of and claims the benefit of PCT Patent Application No. PCT/CN2022/116746 filed on Sep. 2, 2022 in the English language in the State Intellectual Property Office and designating the United States, the contents of which are hereby incorporated herein by reference in its entirety.

### BACKGROUND

Many messaging applications, such as IMESSAGE, WHATSAPP, WECHAT, etc., may provide for sending an image (e.g., a picture) within a message. For example, a user may use a messaging application on their device to send a message that includes an image to a device of a recipient. If a message includes an image, some messaging applications generate a representation of the image (commonly referred to as a “thumbnail image” or simply a “thumbnail”) and send the generated thumbnail image with the message to the recipient's device. Generating and sending the thumbnail image allows the messaging application on the recipient's device to display a preview of the image instead of the original image.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

It is appreciated herein that, with existing message applications, it can be difficult for a recipient to comprehend a message if it includes a thumbnail in place of an original image. For example, in some cases, the thumbnail image may show only a portion of the original image, such as the middle or center portion of the image. In this case, unless the middle portion of the image happens to be related to the topic of the messaging session, a message recipient may not be able to comprehend the message using the thumbnail. In other cases, a thumbnail image may correspond to a scaled down (i.e., smaller) version of the original image. In this case, the message recipient may not be able to view the relevant content due the small size of the thumbnail image. In any case, the message recipient may need to download and open the original, full image in order to view the relevant content. Such effort can be time-consuming and inconvenient for the message recipient and result in increased resource usage (e.g., bandwidth and processing cycles) at the recipient's device. Embodiments of the present disclosure can address these drawbacks by generating and displaying a thumbnail image that shows the portion of the original image related to the topic of the messaging session.

In accordance with one example embodiment provided to illustrate the broader concepts, systems, and techniques described herein, a method includes, by a computing device, determining a topic of an electronic messaging session and determining whether a message including an image is being sent within the messaging session. The method also includes, responsive to a determination of a sending of a message including an image within the messaging session, by the computing device, determining contents of the image associated with the topic of the messaging session, generating a thumbnail image to include the contents of the image associated with the topic of the messaging session, and sending the generated thumbnail image with the message to another computing device.

In some embodiments, the contents of the image associated with the topic is centered in the thumbnail image. In some embodiments, the determining the topic of the electronic messaging session includes applying natural language processing (NLP) to one or more messages in the messaging session. In some embodiments, the determining the topic of the electronic messaging session includes applying a machine learning (ML) model to one or more messages in the messaging session.

In some embodiments, the determining contents of the image associated with the topic of the messaging session includes determining coordinates of a portion of the image which includes the content associated with the topic of the messaging session. In one aspect, the determining coordinates of the portion of the image includes applying optical character recognition (OCR) to the image. In another aspect, the determining coordinates of the portion of the image includes applying image labeling to the image.

In some embodiments, the generating the thumbnail image includes modifying an existing thumbnail image to include the contents of the image associated with the topic of the messaging session. In some embodiments, the computing device is a client and the another computing device is a server. In some embodiments, the computing device is a server and the another computing device is a client.

According to another illustrative embodiment provided to illustrate the broader concepts described herein, a computing device includes a processor and a non-volatile memory storing computer program code that when executed on the processor, causes the processor to execute a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4 is a diagram of an illustrative network environment for intelligent thumbnail images for messaging applications, in accordance with an embodiment of the present disclosure.

FIG. 5 is a block diagram of an illustrative client that can be used within the network environment of FIG. 4, in accordance with an embodiment of the present disclosure.

FIG. 6 shows an example of a user interface (UI) that can be used to present an electronic message, in accordance with an embodiment of the present disclosure.

FIG. 7 shows an example of a user interface (UI) that can be used to present a thumbnail of an image.

FIG. 8 shows an example of a user interface (UI) that can be used to present a thumbnail of an image included in an electronic message, in accordance with an embodiment of the present disclosure.

FIG. 9 is a flow diagram of an illustrative process for intelligently generating a thumbnail of an image included in an electronic message, in accordance with an embodiment of the present disclosure.

### DETAILED DESCRIPTION

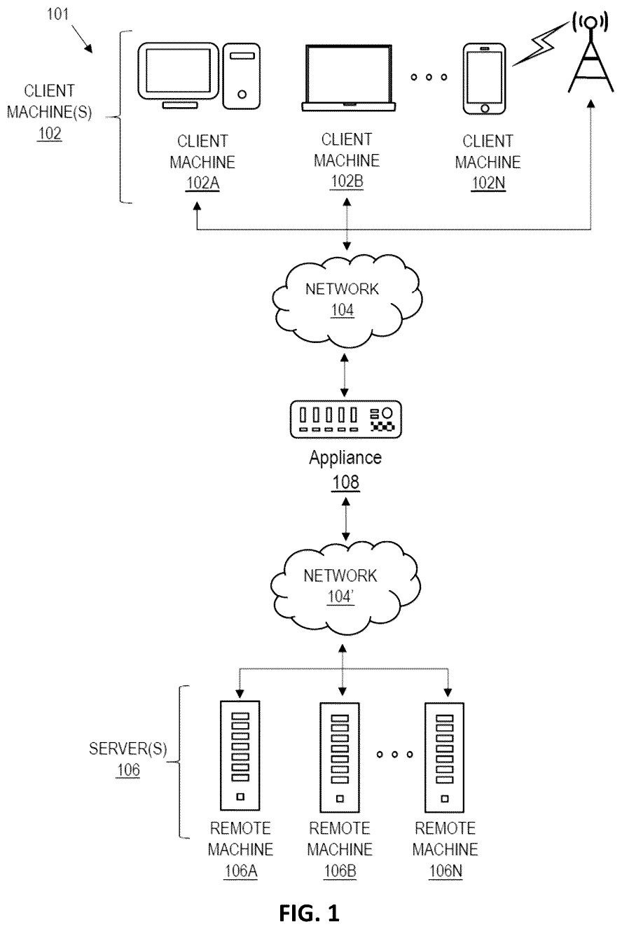

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (Vol P) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

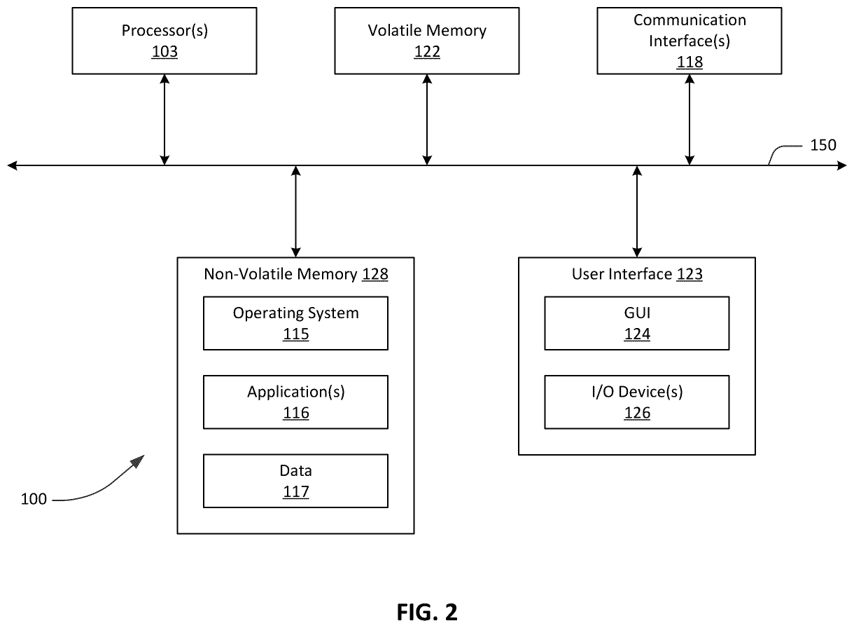

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

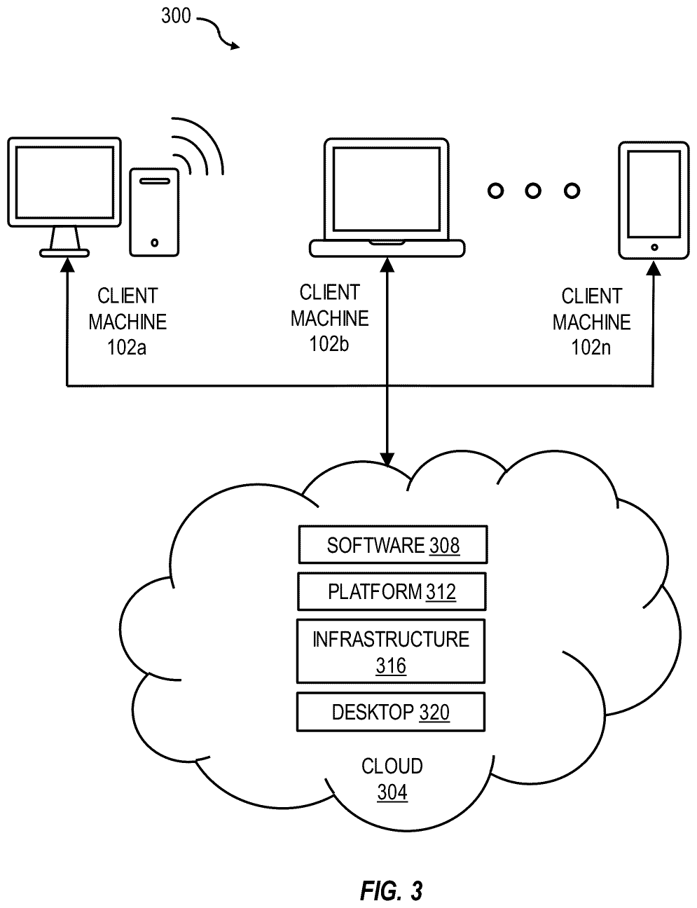

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (laaS) 316, and Desktop as a Service (DaaS) 320, for example. laaS may refer to a user renting the use of infrastructure resources that are needed during a specified time period. laaS providers may offer storage, networking, servers or virtualization resources from large pools, allowing the users to quickly scale up by accessing more resources as needed. Examples of laaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by laaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

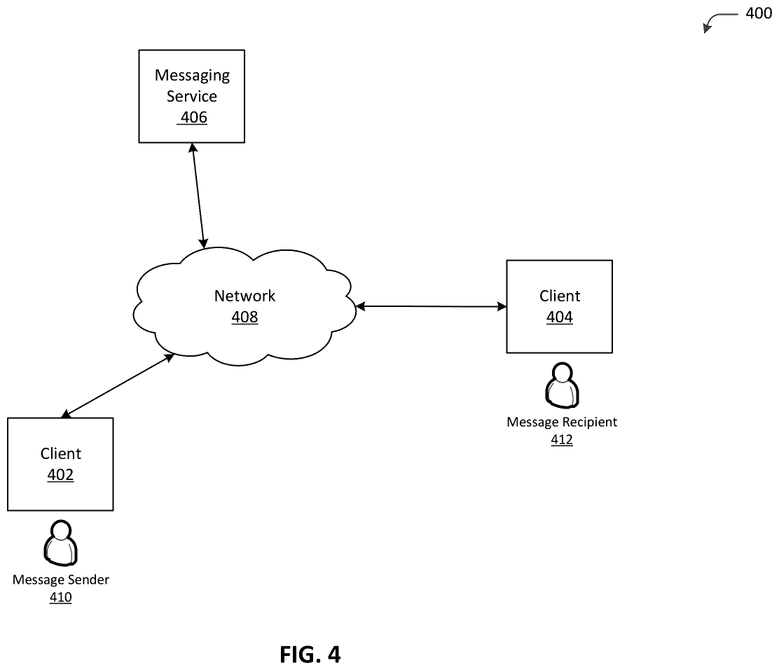

FIG. 4 is a diagram of an illustrative network environment 400 for intelligent thumbnail images for messaging applications, in accordance with an embodiment of the present disclosure. As shown, illustrative network environment 400 includes a first client 402, a second client 404, and a messaging service 406. Clients 402, 404 may be configured to communicate with messaging service 406 via one or more computer networks 408 (e.g., via the Internet). In some embodiments, clients 402, 404 may communicate directly with each other, e.g., using peer-to-peer (P2P) communication, as discussed further below.

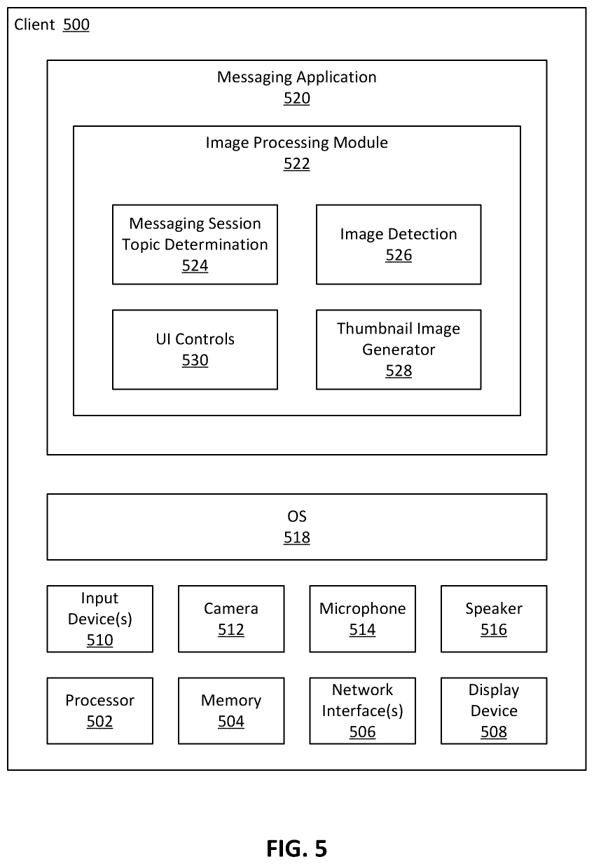

In the example of FIG. 4, a message sender 410 can use first client (or “sender client”) 402 to send an electronic message (or “message”) to a message recipient 412 using second client (or “recipient client”) 404. Client 402, 404 can include, for example, desktop computing devices, laptop computing devices, tablet computing devices, and/or mobile computing devices. Clients 402, 404 can be configured to run one or more applications, such as desktop applications, mobile applications, and SaaS applications. Among various other types of applications, clients 402, 404 can run an application that provides messaging functionality (referred to generally as a “messaging application”). For example, clients 402, 404 can run a messaging application, such as IMESSAGE, WHATSAPP, WECHAT, ZOOM Chat, SKYPE, or another messaging application, which provides the ability to send and receive messages within an electronic messaging session (or “messaging session”), for example. The messaging application running on clients 402, 404 can communicate with messaging service 406 and/or with messaging applications running on other clients 402, 404 (e.g., using P2P communication). In some embodiments, a client 402, 404 may be the same or substantially similar to a client machine 102A-102N described above in the context of FIG. 1 and FIG. 3 and/or computing device 100 described above in the context of FIG. 2. An example of a client that may be the same as or similar to sender client 402 and/or recipient client 404 is described below with respect to FIG. 5. While only one recipient client 404 is shown in FIG. 4, the structures and techniques sought to be protected herein can be applied to any number of message recipients and recipient clients.

Messaging service 406 may correspond to any service that enables sender client 402 to send a message (e.g., a private chat message, a group chat message, etc.) to recipient client 404. For example, messaging service 406 may correspond to a messaging and/or collaboration service such as WECHAT, WHATSAPP, SKYPE, ZOOM, etc. In some embodiments, messaging service 406 may correspond to a SaaS application running in the cloud (e.g., within cloud network 304 of FIG. 3). In some embodiments, messaging service 406 may be omitted and messaging applications running on clients 402, 404 may directly communicate with each other using P2P communication.

In the example of FIG. 4, message sender 410 using sender client 402 and message recipient 412 using recipient client 404 may be participating in an electronic messaging session (also referred to herein more simply as a “messaging session”). In some embodiments, the messaging session may be a client-server messaging session where messaging service 406 enables the respective messaging applications on clients 402, 404 to participate in the messaging session. In other embodiments, the messaging session may be a peer-to-peer messaging session where the messaging application on sender client 402 and the messaging application on recipient client 404 communicate directly, functionally independent of a messaging service, such as messaging service 406.

Message sender 410 may use a messaging application on sender client 402 to send and receive messages as part of a messaging session (e.g., “messaging conversation”) between message sender 410 and message recipient 412 using recipient client 404. When message sender 410 uses sender client 402 sends a message to message recipient 412 using recipient client 404, the messaging application on sender client 402 can identify a messaging session to which the message belongs and determine a topic of the messaging session. For example, the messaging application can determine the topic of the messaging session from or based on the last or most recent message within the messaging session. The last message within the messaging session may be the message sent by message sender 410. As another example, the messaging application can determine the topic of the messaging session from or based on the last or most recent N (e.g., N=3) messages within the messaging session, where N is a configurable parameter. In any case, having determined the topic of the messaging session, the messaging application on sender client 402 can send the message to message recipient 412. The messaging application on sender client 402 can also store the determined topic of the messaging session for later use.

The messaging application on the clients can monitor the sending of messages for messages which include images (e.g., pictures). For example, message sender 410 may use a messaging application on sender client 402 to send a message which includes an image (e.g., a picture) to message recipient 412 using recipient client 404. Upon determining that the message being sent by message sender 410 includes an image, the messaging application on sender client 402 can determine the contents of the image that is associated with the topic of the messaging session to which the message belongs. For example, the messaging application can analyze the image to determine the contents of the image that is related to or otherwise associated with the topic of the messaging session to which the message belongs. The messaging application on sender client 402 can generate a thumbnail image to include the contents of the image associated with the topic of the messaging session. That is to say, the generated thumbnail image shows the contents from the portion of the image that is associated with the topic of the messaging session. The messaging application on sender client 402 can then send the generated thumbnail image with the message to message recipient 412. Upon receiving the message and the thumbnail image, the messaging application on recipient client 404 can display the thumbnail image with the message. The displayed thumbnail image shows the contents of the image that is related to the topic of the messaging session (e.g., a display of the thumbnail image shows the contents from the portion of the image that is related to the topic of the messaging session).

FIG. 5 is a block diagram of an illustrative client 500 that can be used within network environment 400 of FIG. 4, in accordance with an embodiment of the present disclosure. For example, client 500 can correspond to sender client 402 and/or recipient client 404 of FIG. 4. Illustrative client 500 can include a processor 502, a memory 504, one or more network interfaces 506, a display device 508, one or more input devices 510, a camera 512, a microphone 514, and a speaker 516. Memory 504 can store executable instructions for an operating system (OS) and one or more applications, and processor 502 can be configured to execute/run the OS and applications using the stored executable instructions. Display device 508 may be provided, for example, as a monitor or a touchscreen device. Input devices 510 may include, for example, a mouse, a keyboard, a touchpad, a touchscreen, or a stylus, to provide a few examples. Camera 512 can include a webcam or other type of camera capable of capturing video in real time, including video of objects with the camera's field of view. Microphone 514 can include to any device that converts sound (e.g., speech) into an audio signal and speaker 516 can include any device that converts an audio signal into a corresponding sound. In some embodiments, microphone 514 and speaker 516 may be collectively provided as a headset or as headphones. Display device 508, input devices 510, camera 512, microphone 514, and/or peaker 516 can be included as parts of client 500 or can otherwise be connected to or accessible thereby.

Client 500 can also include an OS 518 and a messaging application 520 among various other applications. Messaging application 520 may correspond to any application that enables users to send and receive messages such as, for example, instant messages or chat messages. In some embodiments, messaging application 520 may correspond to IMESSAGE, WHATSAPP, WECHAT, ZOOM Chat, SKYPE, or another messaging application that can provide the ability to send and receive messages within a messaging session, for example. Messaging application 520 may connect to a messaging service (e.g., messaging service 406 of FIG. 4) via one or more computer networks (e.g., networks 408 of FIG. 4) to send and receive messages.

Client 500 may be associated with one or more users. For example, a user may authenticate themselves with client 500 by providing authentication credentials, such as a user identifier (or “user id”) and a password. The user may then use messaging application 520 to send and receive messages as part of a messaging session between the user and other users (e.g., other messaging participants). A user that is actively using client 500 may be referred to as the “current user” of the client.

Client 500 can further include an image processing module 522. Image processing module 522 may be configured to monitor messages being sent using messaging application 520 for messages which include images and, responsive to a determination that a message includes an image, determine the contents of the image that is associated with a topic of a messaging session to which the message belongs, generate a thumbnail image to include the determined contents of the image associated with the topic of the messaging session, and provide the generated thumbnail image for sending with the message. For example, image processing module 522 can provide the generated thumbnail image to messaging application 520 for sending with the message. Image processing module 522 can include various submodules such as a messaging session topic determination module 524, an image detection module 526, and a thumbnail image generator module 538.

Messaging session topic determination module 524 can receive, as input, a message being sent via messaging application 520 and determine a topic of a messaging session to which the message belongs. For example, when messaging application 520 on client 500 is being used to send a message to another client, messaging application 520 can send or otherwise provide the message to messaging session topic determination module 524. In response to a message being received, messaging session topic determination module 524 can identify a messaging session to which the received message belongs. Messaging session topic determination module 524 can then determine a topic of the messaging session from or based on the messages that are in the messaging session. In some embodiments, messaging session topic determination module 524 can utilize various natural language processing (NLP) techniques, such as Latent Dirichlet Allocation (LDA) or other topic modeling and/or machine learning-based techniques, to determine a topic of the messaging session. Topic modeling is an unsupervised machine learning technique that is capable of scanning a collection of documents (e.g., text-based documents), detecting word and phrase patterns within the document(s), and discovering the “topics” that occur in the document(s). In other words, topic modeling can be used as a text-analysis tool for discovering latent semantic structures in a text body. For example, in some such embodiments, messaging session topic determination module 524 can utilize NLP techniques to analyze the text of the last or most recent N (e.g., N=1, 2, 4, etc.) messages in a messaging session to determine a topic of the messaging session. Messaging session topic determination module 524 can also optionally analyze other metadata associated with the N messages (e.g., information about the message sender, information about the message recipient, etc.) to determine a topic of the messaging session. The value of N may be a configurable parameter. In the case where a messaging session does not include N messages (e.g., the messaging session includes less than N messages), the topic of the messaging session may be determined from or based on the messages that are in the messaging session. Messaging session topic determination module 524 can store the determined topic for later use.

Image detection module 526 can inspect a message and determine whether the message includes an image (e.g., a picture). For example, messaging session topic determination module 524 can send or otherwise provide a message provided by messaging application 520 to image detection module 526. In response to a message being received, image detection module 526 can scan, parse, analyze, or otherwise inspect the message to determine whether the message includes an image. If it is determined that the message includes an image, image detection module 526 can send a request to thumbnail image generator module 528 to generate a thumbnail of the image. The request sent to thumbnail image generator module 528 can include the image found in the message or information regarding a location of the image (e.g., information indicating where the image can be found).

In response to a request to generate a thumbnail image being received, thumbnail image generator module 528 can generate a thumbnail of an image. To generate the thumbnail image, in some embodiments, thumbnail image generator module 528 can use optical character recognition (OCR) to extract any text (e.g., text content) included therein. It will be appreciated that other methods/techniques of text extraction may also be used to extract the text content from the image. Thumbnail image generator module 528 can then analyze the text content to determine the contents of the image associated with a topic of a messaging session to which the message that includes the image belongs. The position of the portion of the image which includes such content may be expressed using points (e.g., x and y coordinates) that define the portion of the image, such as points defining a rectangle (“bounding box”).

In some embodiments, thumbnail image generator module 528 may use machine learning-based object detection techniques, such as image labeling, to identify and analyze the contents within an image to determine the portion of the image which includes content associated with a topic of a messaging session to which the message that includes the image belongs. Thumbnail image generator module 528 can then generate a thumbnail image to include the contents of the image associated with the topic of the messaging session to which the message that includes the image belongs. The generated thumbnail of the image shows the contents from the portion of the image that is associated with the topic of the messaging session. to which the message that includes the image belongs. Thumbnail image generator module 528 can then send or otherwise provide the generated thumbnail image to messaging application 520 for sending with the message to the message recipient(s).

In some embodiments, thumbnail image generator module 528 can generate the thumbnail image by modifying an existing thumbnail image to include the contents of the image associated with the topic of the messaging session to which the message that includes the image belongs. The existing thumbnail image may be a previously generated thumbnail of the image which as generated by, for example, messaging application 520 or thumbnail image generator module 528.

In some embodiments, image processing module 522 may include a toggle switch, a checkbox, radio button, or other type of UI control 530 for selectively enabling the functionality of image processing module 522 variously described herein. If image thumbnail generation is disabled, image processing module 522 may not perform the attributed functionality described herein. In other words, if image thumbnail generation is disabled, messaging application 520 may generate thumbnail images for images included in messages as conventionally done.

As shown in FIG. 5, image processing module 522 may be provided as part of messaging application 520. For example, image processing module 522 may be provided as library or as a plugin/extension of messaging application 520. In other embodiments, image processing module 522 may be provided as a standalone application or service that interfaces with messaging application 520 to perform the attributed functionality described herein. For example, image processing module 522 may send/receive data (e.g., message data) to/from messaging application 520 using inter-process communication (IPC) and/or by operating on files (e.g., message files) generated by messaging application 520. In still other embodiments, the disclosed structure and/or functionality of image processing module 522 may be implemented in whole or in part on a server device. For example, the structure/functionality of image processing module 522 may be implemented as part of a messaging service (e.g., messaging service 406 of FIG. 4) and/or within a cloud network (e.g., within cloud network 304 of FIG. 3). In more detail, client 500 may transmit an electronic message to a server device and the server device may perform the operations of modules 524, 526, and 528 to generate a thumbnail image for an image included in a message, wherein the generated thumbnail image includes the contents of the image associated with a topic of a messaging session to which the message belongs. The server device may then transmit the message including the generated thumbnail image to one or more other clients for receipt and display.

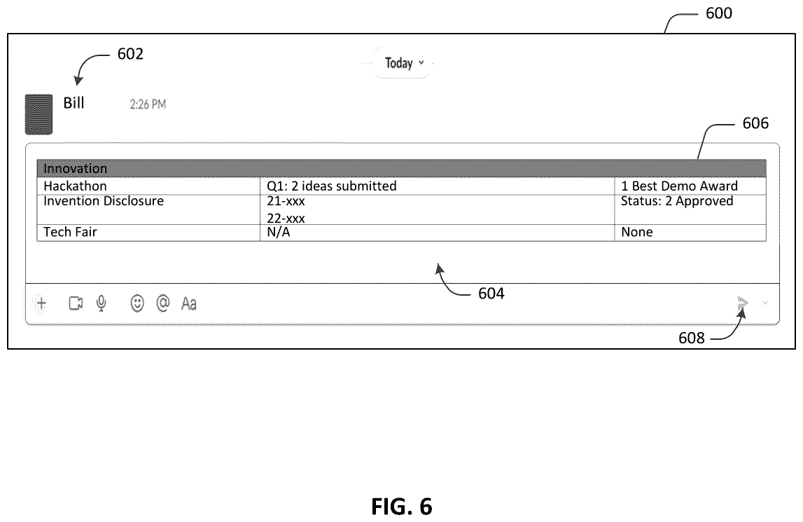

FIG. 6 shows an example of a user interface (UI) 600 that can be used to present an electronic message, in accordance with an embodiment of the present disclosure. Illustrative UI 600 may be implemented within a messaging application, such as messaging application 520 of FIG. 5. UI 600 may operate to enable a user to view, create, and send messages. In the example of FIG. 6 and in the following description thereof, a user named “Bill” is using UI 600 to create and send a message, as indicated by reference numeral 602.

As shown in FIG. 6, user 602 may use UI 600 to create a message 604. Message 604 may be part of a messaging session between user 602 and one or more other users, including a user named “John.” Message 604 may include an image 606 of a table which contains information about innovations which were submitted for review. The topic of the messaging session may be to discuss the awards which were awarded to the submitted innovations. Having created message 604 which includes image 606, user 602 can activate (e.g., click, tap, or select) an icon 608 to send message 604 to the other users, including John, participating in the messaging session. In response to user 602 activating icon 608, the messaging application (e.g., messaging application 520 of FIG. 5) can generate a thumbnail image of image 606 and send message 604 including the generated thumbnail image to the other users participating in the messaging session.

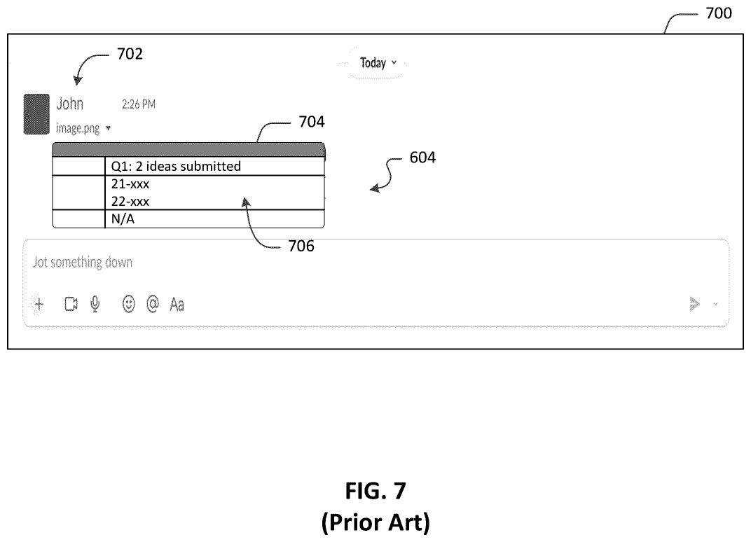

Turning to FIG. 7 and with continued reference to FIG. 6, shown is an example of a user interface (UI) 700 that can be used to present a thumbnail of an image. Illustrative UI 700 may be implemented within a messaging application, such as messaging application 520 of FIG. 5. UI 700 may operate to enable a user to view, create, and send messages. In the example of FIG. 7 and in the following description thereof, a user named “John” is using UI 700 to view a message, as indicated by reference numeral 702.

As shown in FIG. 7, user 702 may use UI 700 to view message 604 sent by user 602. The display of message 604 in UI 700 may include a thumbnail image 704 of image 606 included in message 604. As can be seen, thumbnail image 704 may be of the thumbnail image of image 606 which was generated and sent by the messaging application used by user 602. In the example of FIG. 7, the thumbnail image shown in thumbnail image 704 may have been generated without regard to the topic of the messaging session to which message 604 belongs (i.e., without regard to the topic of the messaging session which is to discuss the awards which were awarded to the submitted innovations). As such, the thumbnail image shown in thumbnail image 704 may show contents 706 of image 606 not associated with the topic of the messaging session.

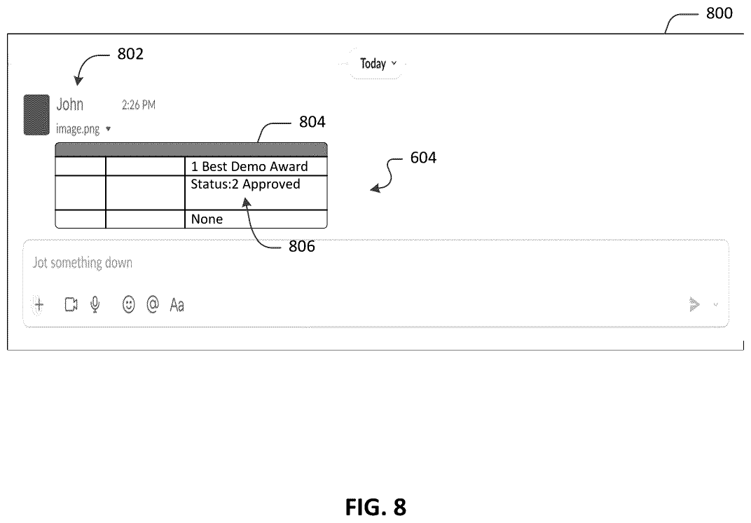

Turning to FIG. 8 and with continued reference to FIG. 6, shown is an example of a user interface (UI) 800 that can be used to present a thumbnail of an image included in an electronic message, in accordance with an embodiment of the present disclosure. Illustrative UI 800 may be implemented within a messaging application, such as messaging application 520 of FIG. 5. UI 800 may operate to enable a user to view, create, and send messages. In the example of FIG. 8 and in the following description thereof, a user named “John” is using UI 800 to view a message, as indicated by reference numeral 802.

As shown in FIG. 8, user 802 may use UI 800 to view message 604 sent by user 602. The display of message 604 in UI 800 may include a thumbnail image 804 of image 606 included in message 604. As can be seen, thumbnail image 804 may be of the thumbnail image of image 606 which was generated and sent by the messaging application used by user 602. In the example of FIG. 8, the thumbnail image shown in thumbnail image 804 may have been generated to include contents 806 of image 606 associated with the topic of the messaging session to which message 604 belongs (i.e., to show the contents of image 606 related to the discussion of the awards which were awarded to the submitted innovations). As such, the thumbnail image shown in thumbnail image 804 may show contents 806 from the portion of image 606 that is associated with the topic of the messaging session.

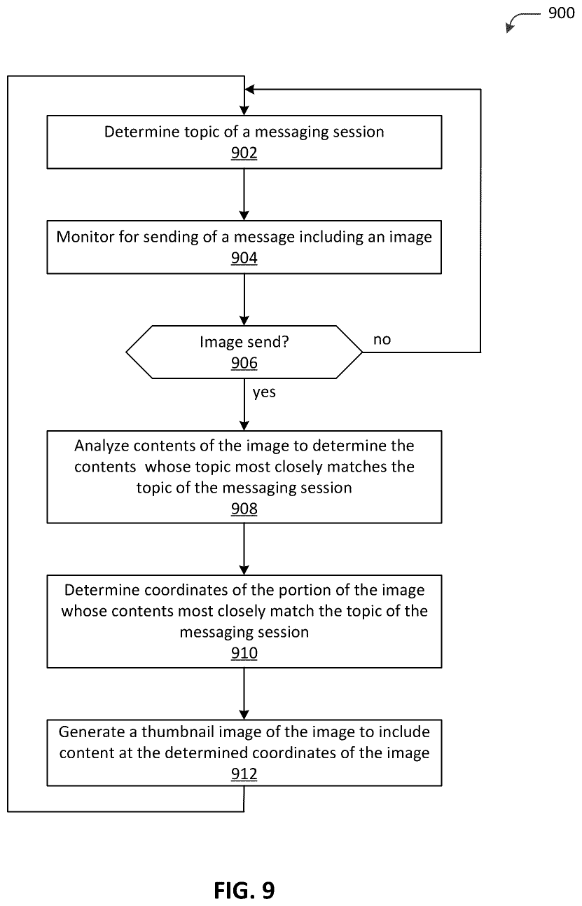

FIG. 9 is a flow diagram of an illustrative process 900 for intelligently generating a thumbnail of an image included in an electronic message, in accordance with an embodiment of the present disclosure. Illustrative process 900 may be implemented, for example, by a computing device associated with a user, such as client 500 of FIG. 5. In some embodiments, at least a portion of process 900 of FIG. 9 may be implemented within a server device.

Referring to process 900, at 902, a topic of a messaging session is determined. For example, users (e.g., message sender 410 and message recipient 412 of FIG. 4, among others) may be participating in a messaging session using respective computing devices (e.g., client 402 and client 404 of FIG. 4). When a message is being sent, the message may be analyzed to determine the topic of the messaging session to which the message belongs. For example, the text of the message can be analyzed using machine learning techniques to determine the topic of the messaging session. If the determined topic of the messaging session is different than a previously determined topic of the messaging session, the topic may be updated to the more recently determined topic.

At 904, the sending of messages within the messaging session is monitored for messages which include images. At 906, the message that is being sent can be checked to determine whether the message includes an image. For example, the message being sent can be inspected to determine whether an image is being sent.

If it is determined that an image is not being sent (e.g., the message does not include an image), at 902, the next message being sent in the messaging session can be processed. That is, the message that is being sent without an image is processed normally and sent to the users participating in the messaging session, and the next message being sent in the messaging session may be processed.

Otherwise, if it is determined that an image is being sent (e.g., the message includes an image), at 908, the contents of the image is analyzed to determine the contents whose topic most closely matches the topic of the messaging session. For example, a text extraction technique, such as OCR, can be applied to the image to extract the text content included in the image. The text content of the image can then be analyzed to determine the contents of the image that is associated with the topic of the messaging session to which the message that is being sent belongs.

At 910, the coordinates of the portion of the image whose contents most closely match the topic of the messaging session is determined. The coordinates define the position of the portion of the image which includes the contents whose topic most closely matches (e.g., whose topic is associated with) the topic of the messaging session.

At 912, a thumbnail image to include the content at the determined coordinates of the image is generated. The generated thumbnail image includes the content from the portion of the image defined by the determined coordinates. The content from this portion of the image is the content that most closely matches the topic of the messaging session (e.g., the content that is associated with the topic of the messaging session). The generated thumbnail of the image may then be provided for sending with the message and, at 902, the next message being sent in the messaging session can be processed.

### Further Example Embodiments

The following examples pertain to further embodiments, from which numerous permutations and configurations will be apparent.

Example 1 includes a method including: determining, by a computing device, a topic of an electronic messaging session; and, responsive to a determination of a sending of a message including an image within the messaging session, by the computing device, determining contents of the image associated with the topic of the messaging session; generating a thumbnail image to include the contents of the image associated with the topic of the messaging session; and sending the generated thumbnail image with the message to another computing device.

Example 2 includes the subject matter of Example 1, wherein the contents of the image associated with the topic is centered in the thumbnail image.

Example 3 includes the subject matter of any of Examples 1 and 2, wherein the determining the topic of the electronic messaging session includes applying natural language processing (NLP) to one or more messages in the messaging session.

Example 4 includes the subject matter of any of Examples 1 through 3, wherein the determining the topic of the electronic messaging session includes applying a machine learning (ML) model to one or more messages in the messaging session.

Example 5 includes the subject matter of any of Examples 1 through 4, wherein the determining of the contents of the image associated with the topic of the messaging session includes determining coordinates of a portion of the image which includes the content associated with the topic of the messaging session.

Example 6 includes the subject matter of Example 5, wherein the determining coordinates of the portion of the image includes applying optical character recognition (OCR) to the image.

Example 7 includes the subject matter of Example 5, wherein the determining coordinates of the portion of the image includes applying image labeling to the image.

Example 8 includes the subject matter of any of Examples 1 through 7, wherein the generating the thumbnail image includes modifying an existing thumbnail image to include the contents of the image associated with the topic of the messaging session.

Example 9 includes the subject matter of any of Examples 1 through 8, wherein the computing device is a client and the another computing device is a server.

Example 10 includes the subject matter of any of Examples 1 through 8, wherein the computing device is a server and the another computing device is a client.

Example 11 includes a computing device including a processor and a non-volatile memory storing computer program code that when executed on the processor causes the processor to execute a process including: determining a topic of an electronic messaging session; and, responsive to a determination of a sending of a message including an image within the messaging session, determining contents of the image associated with the topic of the messaging session; generating a thumbnail image to include the contents of the image associated with the topic of the messaging session; and sending the generated thumbnail image with the message to another computing device.

Example 12 includes the subject matter of Example 11, wherein the contents of the image associated with the topic is centered in the thumbnail image.

Example 13 includes the subject matter of any of Examples 11 and 12, wherein the determining the topic of the electronic messaging session includes applying natural language processing (NLP) to one or more messages in the messaging session.

Example 14 includes the subject matter of any of Examples 11 through 13, wherein the determining the topic of the electronic messaging session includes applying a machine learning (ML) model to one or more messages in the messaging session.

Example 15 includes the subject matter of any of Examples 11 through 14, wherein the determining of the contents of the image associated with the topic of the messaging session includes determining coordinates of a portion of the image which includes the content associated with the topic of the messaging session.

Example 16 includes the subject matter of Example 15, wherein the determining coordinates of the portion of the image includes applying optical character recognition (OCR) to the image.

Example 17 includes the subject matter of Example 15, wherein the determining coordinates of the portion of the image includes applying image labeling to the image.

Example 18 includes the subject matter of any of Examples 11 through 17, wherein the generating the thumbnail image includes modifying an existing thumbnail image to include the contents of the image associated with the topic of the messaging session.

Example 19 includes the subject matter of any of Examples 11 through 18, wherein the computing device is a client and the another computing device is a server.

Example 20 includes the subject matter of any of Examples 11 through 18, wherein the computing device is a server and the another computing device is a client.

Example 21 includes a non-transitory machine-readable medium encoding instructions that when executed by one or more processors cause a process to be carried out. The process includes: determining a topic of an electronic messaging session; and, responsive to a determination of a sending of a message including an image within the messaging session, determining contents of the image associated with the topic of the messaging session; generating a thumbnail image to include the contents of the image associated with the topic of the messaging session; and sending the generated thumbnail image with the message to a computing device.

Example 22 includes the subject matter of Example 21, wherein the contents of the image associated with the topic is centered in the thumbnail image.

Example 23 includes the subject matter of any of Examples 21 and 22, wherein the determining the topic of the electronic messaging session includes applying natural language processing (NLP) to one or more messages in the messaging session.

Example 24 includes the subject matter of any of Examples 21 through 23, wherein the determining the topic of the electronic messaging session includes applying a machine learning (ML) model to one or more messages in the messaging session.

Example 25 includes the subject matter of any of Examples 21 through 24, wherein the determining of the contents of the image associated with the topic of the messaging session includes determining coordinates of a portion of the image which includes the content associated with the topic of the messaging session.

Example 26 includes the subject matter of Example 25, wherein the determining coordinates of the portion of the image includes applying optical character recognition (OCR) to the image.

Example 27 includes the subject matter of Example 25, wherein the determining coordinates of the portion of the image includes applying image labeling to the image.

Example 28 includes the subject matter of any of Examples 21 through 27, wherein the generating the thumbnail image includes modifying an existing thumbnail image to include the contents of the image associated with the topic of the messaging session.

Example 29 includes the subject matter of any of Examples 21 through 28, wherein the computing device is a client.

Example 30 includes the subject matter of any of Examples 21 through 28, wherein the computing device is a server.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

1. A method comprising:
determining, by a computing device, a topic of an electronic messaging session; and
responsive to a determination of a sending of a message including an image within the messaging session, by the computing device:
determining contents of the image associated with the topic of the messaging session;
generating a thumbnail image to include the contents of the image associated with the topic of the messaging session; and
sending the generated thumbnail image with the message to another computing device.

2. The method of claim 1, wherein the contents of the image associated with the topic is centered in the thumbnail image.

3. The method of claim 1, wherein the determining the topic of the electronic messaging session includes applying natural language processing (NLP) to one or more messages in the messaging session.

4. The method of claim 1, wherein the determining the topic of the electronic messaging session includes applying a machine learning (ML) model to one or more messages in the messaging session.

5. The method of claim 1, wherein the determining of the contents of the image associated with the topic of the messaging session includes determining coordinates of a portion of the image which includes the content associated with the topic of the messaging session.

6. The method of claim 5, wherein the determining coordinates of the portion of the image includes applying optical character recognition (OCR) to the image.

7. The method of claim 5, wherein the determining coordinates of the portion of the image includes applying image labeling to the image.

8. The method of claim 1, wherein the generating the thumbnail image includes modifying an existing thumbnail image to include the contents of the image associated with the topic of the messaging session.

9. The method of claim 1, wherein the computing device is a client and the another computing device is a server.

10. The method of claim 1, wherein the computing device is a server and the another computing device is a client.

11. A computing device comprising:
a processor; and
a non-volatile memory storing computer program code that when executed on the processor causes the processor to execute a process including:
determining a topic of an electronic messaging session; and
responsive to a determination of a sending of a message including an image within the messaging session:
determining contents of the image associated with the topic of the messaging session;
generating a thumbnail image to include the contents of the image associated with the topic of the messaging session; and
sending the generated thumbnail image with the message to another computing device.

11. (canceled)

12. The computing device of claim 11, wherein the determining the topic of the electronic messaging session includes applying natural language processing (NLP) to one or more messages in the messaging session.

13. The computing device of claim 11, wherein the determining the topic of the electronic messaging session includes applying a machine learning (ML) model to one or more messages in the messaging session.

14. The computing device of claim 11, wherein the determining of the contents of the image associated with the topic of the messaging session includes determining coordinates of a portion of the image which includes the content associated with the topic of the messaging session.

15. The computing device of claim 14, wherein the determining coordinates of the portion of the image includes applying optical character recognition (OCR) to the image.

16. The computing device of claim 14, wherein the determining coordinates of the portion of the image includes applying image labeling to the image.

17. The computing device of claim 11, wherein the generating the thumbnail image includes modifying an existing thumbnail image to include the contents of the image associated with the topic of the messaging session.

18. A non-transitory machine-readable medium encoding instructions that when executed by one or more processors cause a process to be carried out, the process including:
determining a topic of an electronic messaging session; and
responsive to a determination of a sending of a message including an image within the messaging session:
determining contents of the image associated with the topic of the messaging session;
generating a thumbnail image to include the contents of the image associated with the topic of the messaging session; and
sending the generated thumbnail image with the message to another computing device.

19. The machine-readable medium of claim 18, wherein the determining the topic of the electronic messaging session includes one of applying natural language processing (NLP) to one or more messages in the messaging session or applying a machine learning (ML) model to one or more messages in the messaging session.

20. The machine-readable medium of claim 18, wherein the determining of the contents of the image associated with the topic of the messaging session includes determining coordinates of a portion of the image which includes the content associated with the topic of the messaging session.
